(19) United States
(12) Patent Application Publication
(10) Pub. No.: US 2005/0010797 A1
(43) Pub. Date: Jan. 13, 2005

(54) Surveillance system and method

(76) Inventor: Andrew Broxholme Rushworth, Palmerston North (NZ)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/490,185

(22) PCT Filed: Sep. 20, 2002
(86) PCT No.: PCT/NZ02/00187

(30) Foreign Application Priority Data
Sep. 20, 2001 (NZ) 514311

(51) Int. Cl. H04L 9/00

(52) U.S. Cl. 713/200

(57) ABSTRACT

The invention provides a surveillance system comprising one or more sensors connected to a network, at least one of the sensors configured to transmit messages over the network to other devices connected to the network. The system also comprises one or more video cameras capable of controlled movement between multiple positions and a video capture device interfaced to the video cameras configured to obtain one or more digital images from the video cameras. An image interpreter is configured to identify the presence of one or more objects in an image obtained by the video capture device and a controller connected to the network configured, on detecting transmission over the network of a message representing an event, to position one or more of the video cameras to obtain an optimal image of at least part of the object or objects identified by the image interpreter in the image obtained by the video capture device. The invention also provides a method of surveillance comprising the steps of monitoring messages transmitted over a network by one or more sensors connected to the network; and positioning one or more video cameras, on transmission over the network of a message representing an event, to obtain an optimal image of at least part of an object or objects in the image obtained using the video camera or cameras.

### FIELD OF INVENTION

The invention relates to an intelligent video control system and method for monitoring multiple lanes of slow moving or stationary traffic using a reduced number of controllable cameras, and for the integration of the information derived from the transaction data and the associated video footage into commercial systems.

### BACKGROUND OF THE INVENTION

Covering large, open areas such as retail service station forecourts with video cameras presents a wide range of problems. One solution is using multiple fixed cameras, but this increases significantly the cost of equipment, installation, and maintenance, as well as to excessive quantities of redundant video footage being captured.

An alternative to multiple fixed cameras is the use of an automated dome camera that ‘roams’, talking random video footage by running through a preset number of positions. Using a dome camera reduces the number of cameras required, but introduces the possibility of the camera missing footage from areas at the time of key events.

An enhancement to the use of a dome camera that ‘roams’, taking random video footage, is the dome camera being instructed to move to a preset position based on an event that occurs on the service station forecourt, such as a dispenser nozzle being lifted. This implementation does not provide sufficient accuracy to associate the dispenser nozzle that was lifted with the vehicle that is located adjacent to that dispenser. Further, this implementation does not provide the details of the fuelling transaction, and does not associate the transaction details with the correct vehicle.

It would be particularly desirable to provide a system which avoids the cost and expense of multiple fixed cameras and which reduces the possibility of the camera or cameras missing footage from areas at the time of key events. It would be further desirable to provide a system that can provide the transaction details, and can correctly associate the transaction details with the correct vehicle located adjacent to the dispenser and with video footage related to the transaction, providing a visual audit trail of the transaction.

### SUMMARY OF THE INVENTION

In broad terms in one form the invention comprises a surveillance system comprising: one or more fuel dispensers connected to a network, one or more sensors connected to the network, at least one of the sensors configured to transmit messages over the network to other devices connected to the network; one or more video camera(s) capable of controlled movement between multiple positions; a video capture device interfaced to the video camera(s) configured to obtain one or more digital images from the video camera(s); an image interpreter configured to identify the presence of one or more objects in an image obtained by the video capture device; and a controller connected to the network, the controller configured, on detecting transmission over the network of a message representing an event, to position one or more of the video cameras to obtain an optimal image of at least part of the object(s) identified by the image interpreter in the image obtained by the video capture device.

In broad terms in another form the invention comprises a method of surveillance comprising the steps of: monitoring messages transmitted over a network by one or more sensors connected to the network, and one or more fuel dispensers connected to the network; and positioning one or more video cameras, on transmission over the network of a message representing an event, to obtain an optimal image of at least part of an object(s) in the image obtained using the video camera(s).

### BRIEF DESCRIPTION OF THE DRAWINGS

Preferred forms of implementation of the surveillance system and method are described below with reference to the accompanying figures.

FIG. 1 shows a block diagram of one implementation of the invention, in which all components of the invention are located locally on site; and

FIG. 2 shows a block diagram of a further implementation of the invention, in which some components of the invention are located locally on site and other components are located on a remote site, for example a central location.

### DETAILED DESCRIPTION OF PREFERRED FORMS

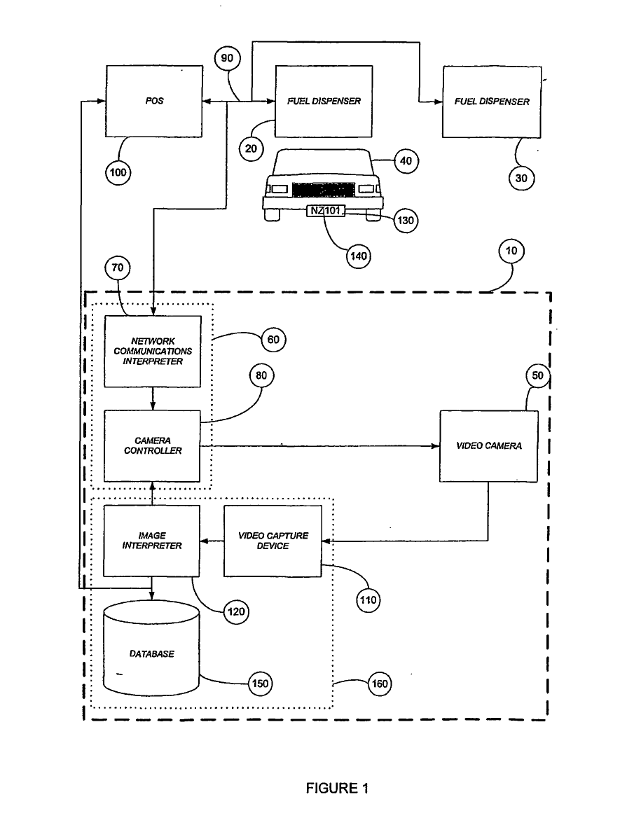

FIG. 1 shows a block diagram of a system 10 in which one form of the invention could be implemented. The system 10 includes one form of the invention used to monitor the delivery of fuel on a service station forecourt, for example gasoline, diesel, propane, or natural gas from fuel dispensers 20 or 30 to a vehicle 40.

The system 10 includes one or more image capture devices for example a video camera 50 or multiple video camera. The video camera 50 is preferably a dome or pan-tilt-zoom camera, which is capable of controlled movement between multiple positions. In system 10 the video camera 50 could be moveable between a first position in which it is directed toward fuel dispenser 20 and a second position in which it is directed toward fuel dispenser 30.

An intelligent controller 60 comprises a network communications interpreter 70 and a camera controller 80. The intelligent controller 60 could be implemented as a programmed microprocessor or alternatively as a hard wired component. It will be appreciated that the network communications interpreter 70 and the camera controller 80 could be implemented as separate controllers forming part of the intelligent controller 60 or alternatively the intelligent controller 60 could be programmed to perform the functions of both the interpreter 70 and the controller 80.

The network communications interpreter 70 is connected to the site communications network 90 and monitors the messages exchanged between the various electronic devices on the network, which include a point of service system 100 (for example a Point of Sale system) or multiple point of service systems, the fuel dispenser 20, and the fuel dispenser 30.

It will be appreciated that the site communications network 90 could be a wired network, a wireless network, or a combination of wired and wireless networks. One or more of the devices on the network, for example the point of service system 100 and the fuel dispensers 20 and 30 could include sensors which are connected to the network 90. These sensors are configured to transmit messages over the network 90 to other devices connected to the network.

The network communications interpreter 70 interprets the messages exchanged on the communications network 90 and recognises the occurrence of key events which include, but are not limited to, nozzle being lifted, fuel delivery start, fuel delivery in progress, fuel delivery stop, and nozzle being replaced in the dispenser. For example, these events could be triggered by the attempt to deliver fuel from the dispenser 20 to the vehicle 40, which is positioned adjacent to it.

The controller 60 is preferably programmed with protocols of the various electronic devices connected to the network. These protocols are generally specific to the manufacturer of the type of item, for example the type of fuel dispenser, point of service system, car wash, and so on. The controller 60 is programmed to recognise the transmittal of messages representing key events such as those described above.

The network communications interpreter 70 then passes the event data to the camera controller 80. The camera controller 80 is capable of controlling the moveable video camera 50. This control extends to being able to adjust the vertical tilt, horizontal pan and zoom of the camera. This serves a dual purpose, to minimise the amount of redundant footage being captured and to optimise the quality of the video image. The camera controller 80 instructs the video camera 50 to move to the location of the key event and to capture images from that location.

The video camera 50 transmits the captured image to the video capture device 110 which digitises the image. It will be appreciated that the video capture device 110 could be unitary within video camera 50, meaning that the video camera 50 could produce digital images without needing a separate video capture device 110. The video capture device 110 could be interfaced to the video camera 50 either forming a single unit, or connected to the video camera 50 by a wired or wireless connection.

The video capture device 110 then sends the digitised image to an image interpreter 120, which identifies whether there is an object of interest, for example a vehicle 40, within the image frame.

The image interpreter 120 in one form could be an image processing component implemented in either software or hardware.

If a vehicle 40 is present in the digital image, the image interpreter 120 passes instructions to controller 60 and/or camera controller 80 to adjust or position the video camera 40 to capture an optimal image of at least part of the object of interest. This part of the object could include a vehicle registration plate 130. It is envisaged that the invention be configured to identify both front and rear mounted vehicle plates on many different vehicles, for example cars, trucks and motorcycles which may have registration plates in different locations on the vehicle.

The controller 60, using the network communications interpreter 70, detects transmission over the network of a message representing an event and the camera controller 60 positions the video camera 50 or video cameras to obtain an optimal image of at least part of the object or objects identified by the image interpreter 120 and the image obtained by the video capture device 110.

Alternatively, the image interpreter 120 could identify a vehicle registration plate initially within the image frame. The camera could then be adjusted to capture a close up of the licence plate, and the shapes on that plate compared to a known character set.

The video camera 50 sends an image of the vehicle registration plate 130 to the video capture device 110. The video capture device 110 digitises the image and passes the digitised image to the image interpreter 120. The image interpreter 120 recognises the alpha-numeric characters that comprise the vehicle registration number 140 on the registration plate 130.

The registration number 140 is then inserted into a database 150, along with the associated transaction data from the triggering event and the captured video footage of the event.

The database 150 comprises a store of site events, with associated data (including the vehicle registration number) and video footage of the event. The invention, through the use of the image interpreter 120, is able to associate particular network events with identified video objects. This could be useful, for example, when two vehicles are fuelling at different retail fuel dispensers simultaneously, for example fuel dispenser 20 and fuel dispenser 30. In these circumstances, the invention could ensure accurate vehicle localisation. That is the invention could associate the details of the fuelling transaction with the correct vehicle based on image analysis.

The associated event data could include for example the type of the event, date and time of the event, the dispenser and nozzle number, the volume of fuel delivered, the unit price of the fuel delivered, the total price of the fuel delivered, and other relevant data.

In the preferred form described above, the image interpreter 120, the database 150, and the video capture device 110 are hosted on a computing device 160 located locally, on site.

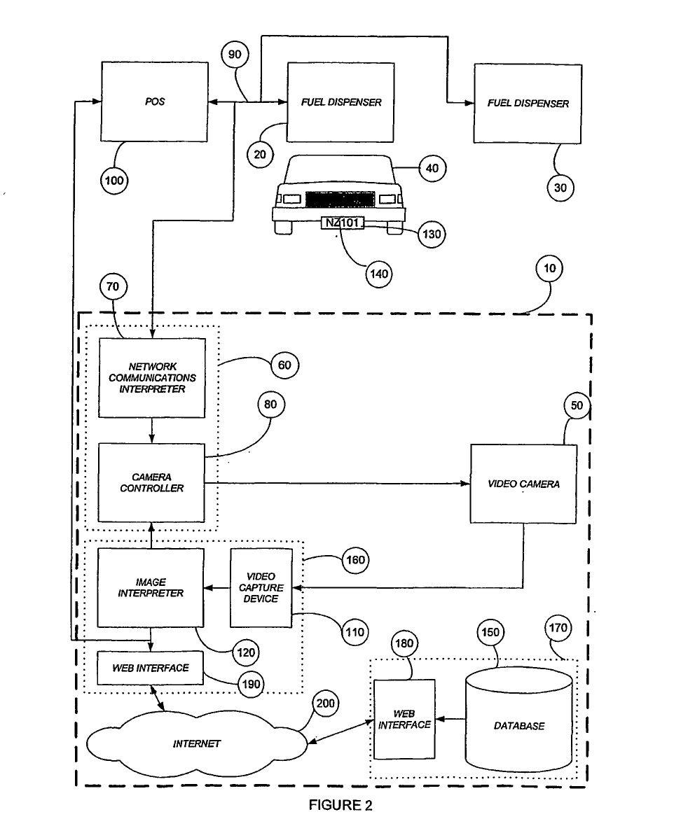

In a further preferred form as depicted in FIG. 2, the image interpreter 120 and the video capture device 110 could be hosted on a computing device 160 located locally, on site, but the database 150 could be hosted on another computing device 170 located at a remote location, for example for centralised site monitoring, for centralised storage and maintenance of registration numbers of vehicles with a fraud or crime history, or for centralised storage and maintenance of customer user account or credit card details. The image interpreter 120 and the remote database 150 communicate via Web interfaces 180 and 190 over the Internet 200.

In the preferred forms described above, the invention could utilise the licence plate recognition functionality for fraud prevention. The invention could be arranged to extract the registration number of the vehicle 40 and to check the vehicle registration number against a list of registration numbers of vehicles with a history of fraud or crime. If the invention detects that the registration number belongs to a vehicle with a history of fraud or crime, fuel dispensing could be prevented. On the other hand, if the registration number belongs to a vehicle that is not listed in the fraudulent vehicles database, fuel dispensing could commence.

In a further preferred form, the invention is able to obtain transaction completion details from the point of service system 100 and to associate the transaction completion details with the transaction data, with the video footage and with the vehicle registration number. For example, transaction completion details could comprise payment details.

In the preferred form described above, the owner of a vehicle 40 could register the license plate data with a particular service station or chain of service stations. The registration data could be stored in database 150 and associated with a point of sale system 100. The user could supply authorisation in advance to debit a user account or to charge a credit card on the sale of fuel or other items from the forecourt. To purchase fuel, a user could then simply drive to a fuel dispenser 20, transfer fuel from the fuel dispenser to the vehicle 40, thereby triggering the capturing and interpretation of the transaction data and associated images, and then exit the forecourt. The vehicle could be identified by the vehicle registration number and the user account debited.

In a further preferred form, it is envisaged that the intelligent controller 60 could communicate with the point of service system 100 and could associate events occurring on the convenience store premises with video footage. For example, the intelligent controller 60, through the network communications interpreter 70, could detect a key event such as the opening of a cash register, or the pressing of a refund key. Further, through a motion detection sensor, the network communications interpreter 70 could detect the entry of a customer into the store. The occurrence of these events could be transmitted through the network communications interpreter 70 to camera controller 80 to position the video camera 50 to capture images of such events.

In a further preferred form, the intelligent controller 60 could monitor one or more sensors installed on the service station forecourt and/or in the convenience store for example for controlling the access to various locations. Upon detecting access attempt, the sensors would send a signal to the intelligent controller 60, which could instruct the video camera 50 to move to the location of the event and capture video footage. The video footage could be stored along with the date and time of the event, or it could be otherwise processed.

In a further preferred form, the video footage and the event and transaction data stored in the database 150 could be accessed over the Internet, with appropriate access security restrictions, for central site monitoring and for analysis of the data for a variety of purposes such as customer loyalty, data warehousing and data mining, or centrally monitored security. A wide range of reports could be defined for the retrieval of the transaction data and associated video footage either locally or over the Internet for various purposes.

For example, in the preferred form described above, the frequency of a certain vehicle fuelling at a service station or group of service stations as well as other purchasing behaviour of the vehicle driver could be analysed by a computer application, and the results of this analysis could be used as input to the development of various promotional activities and customer loyalty programmes.

It is envisaged that the invention could be applied to automatic teller machines in a drive through banking environment or in a non-drive through banking environment in which key events could include ATM (Automatic Teller Machine) card read and transaction completion, night safe opened/closed and/or door opened and/or closed.

It is further envisaged that the invention could be applied to car-wash facilities, car parking facilities, car dealerships, or in the valet parking environment.

It is further envisaged that the application could be applied in shopping centres and other retail environments, manufacturing plants and other industrial environment, restricted access areas, and areas of high health and safety risks.

The invention provides, through controlling the physical movement of an automated video camera, the capturing of business data for a variety of purposes including, but not limited to, security, customer loyalty programmes, data warehousing and data mining, crime prevention, aiding law enforcement organisations and transaction payment.

The foregoing describes the invention including preferred forms thereof. Alterations and modifications as will be obvious to those skilled in the alt are intended to be incorporated within the scope hereof, as defined by the accompanying claims.

1-14. (cancelled)

15. A surveillance system comprising:
one or more fuel dispensers connected to a network,
one or more sensors connected to the network, at least one of the sensors configured to transmit messages over the network to other devices connected to the network;
one or more video camera(s) capable of controlled movement between multiple positions;
a video capture device interfaced to the video camera(s) configured to obtain one or more digital images from the video camera(s);
an image interpreter configured to identify the presence of one or more objects in an image obtained by the video capture device; and
a controller connected to the network, the controller configured, on detecting transmission over the network of a message representing an event, to position one or more of the video cameras to obtain an optimal image of at least part of the object(s) identified by the image interpreter in the image obtained by the video capture device.

16. A surveillance system as claimed in claim 15 wherein one or more of the fuel dispensers incorporates one or more of the sensors.

17. A surveillance system as claim in claim 16 wherein the events represented by the messages include nozzle lift, fuel delivery start, fuel delivery in progress, fuel delivery stop, and/or nozzle replaced.

18. A surveillance system as claims in claim 16 wherein the object(s) identified by the image interpreter include vehicle license plates, the controller configures to position the video camera(s) to obtain an optimal image of a vehicle license plate.

19. A surveillance system as claimed in claim 15 wherein the network has connected to it one or more point of service systems incorporating one or more of the sensors.

20. A surveillance system as claims in claim 19 wherein the events represented by the messages include cash register open and/or refund key press.

21. A surveillance system as claimed in claim 15 wherein controlled movement of the video camera(s) include vertical tilt, horizontal pan and/or zoom.

22. A method of surveillance comprising the steps of:
monitoring messages transmitted over a network by one or more sensors connected to the network; one or more fuel dispensers connected to the network; and
positioning one or more video cameras, on transmission over the network of a message representing an event, to obtain an optimal image of a least part of an object(s) in the image obtained using the video camera(s).

23. A method of surveillance as claimed in claim 22 wherein one or more of the fuel dispensers incorporates one or more of the sensors.

24. A method of surveillance as claimed in claim 23 wherein the events represented by the messages include nozzle lift, fuel delivery start, fuel delivery in progress, fuel delivery stop and/or nozzle replaced.

25. A method of surveillance as claimed in claim 23 wherein the object(s) include vehicle license plates, the method further including the step of positioning the video camera(s) to obtain an optimal image of a vehicle license plate.

26. A method of surveillance as claimed in claim 22 wherein the network has connected to it one or more point of service systems incorporating one or more of the sensors.

27. A method of surveillance as claimed in claim 26 wherein the events represented by the messages include cash register open and/or refund key press.

28. A method of surveillance as claimed in claim 22 wherein the positioning of one or more video camera comprises controlled movement of the video cameras including vertical tilt, horizontal pan and/or zoom.
